(19) United States
(12) Patent Application Publication
(10) Pub. No.: US 2026/0049611 A1
(43) Pub. Date: Feb. 19, 2026

(54) REMOVABLE PUMP HEAD WITH A POLYMERIC SHAFT COUPLER

(71) Applicant: PROCON US, INC., Smyrna, TN (US)

(72) Inventors: Robert R. Kimberlin, Rockvale, TN (US); Jie Jiang, Nashville, TN (US); Brian S. Waters, Carthage, TN (US)

(73) Assignee: PROCON US, INC., Smyrna, TN (US)

(21) Appl. No.: 18/805,053

(22) Filed: Aug. 14, 2024

(51) Int. Cl. F04C 15/00; F04C 2/14

(52) U.S. Cl. CPC F04C 15/0061; A47J 31/057; F04C 2/14; F04C 13/001; F04C 15/0003; F04C 15/003; F04C 15/0034; F04C 15/0038; F04C 2240/50; F04C 2240/60; F04C 2240/80; F05C 2225/00

(57) ABSTRACT

A pump having a pumping module and a motor module. The motor module has an electric motor and a first rotatable shaft driven by the electric motor. The pumping module has a pump housing with an internal pumping chamber, a drive shaft opening, and inlet and outlet ports in flow communication with the pumping chamber. The pumping module also comprises a pumping mechanism disposed within the pumping chamber driven by a second rotatable shaft extending through the drive shaft opening and coupled to the first rotatable shaft by a polymeric coupler.

### FIELD

This disclosure relates to the field of fluid pumps. More particularly, this disclosure relates to a pump having a pumping module removably attached to a motor module and a related coffee making machine utilizing the pump.

### BACKGROUND

In existing pump designs, there is a wide disparity in the service lives of pump motors and the pumping components the motors drive. Typically, motors last from 5 to 10 years, while pumping components may last only 2 to 3 years. In particular, pump designs commonly incorporate pump components such as sealing elements connected to pump motor drive shafts that wear as the pump is used. Commonly, sealing elements are connected to the drive shafts through the use of set screws in base components also holding the seals in place, all of which may break or loosen over time and allow fluids to leak past, or which may need tightening as sealing elements wear through use. Unfortunately, however, pump motors and the pumping components the motors drive typically are not easily separated. Often, sealing elements as discussed above, along with drive shafts connecting motors to pumping mechanism components, pumping mechanism components themselves such as gears or vanes, bearings ensuring smooth operation, and more may be integrally formed or otherwise permanently connected within pumps such that they cannot be easily repaired or replaced. The result is that most motors are discarded before the end of their useful life due to wear on shorter-lived pumping components, which leads to both increased expense and a waste of resources.

Accordingly, what is desired is an improved pump design that is low cost, provides a solution to this disparity in part lifetimes, and operates using an intuitive and mechanically simple, yet effective design.

### SUMMARY

The above and other needs are met by the pump made in accordance with the present disclosure.

In a first aspect, the present disclosure provides a pump including a motor module, the motor module having an electric motor and a first rotatable drive shaft driven by the electric motor, a pumping module that is removably attached to the motor module, and a polymeric coupler having a first end and a second end. The pumping module includes a pump housing with an internal pumping chamber, a drive shaft opening, and an inlet port and outlet port in flow communication with the pumping chamber. The pumping module also includes a second rotatable shaft extending through the drive shaft opening in the pump housing and into the pumping chamber. The pumping module further includes a pumping mechanism driven by the second rotatable shaft disposed within the internal pumping chamber of the pump housing. The pumping mechanism is capable of receiving fluid through the inlet port and into the pumping chamber at a first pressure. The pumping mechanism is also capable of discharging the fluid from the pumping chamber at a second, greater pressure through the outlet port. The polymeric coupler has a first end that is removably attached to the first rotatable shaft and a second end that is removably attached to the second rotatable shaft.

In certain embodiments, the pumping mechanism of the pump includes a gear pump. In one embodiment, the pumping mechanism includes a drive gear with a plurality of drive gear teeth disposed within the pumping chamber. The drive gear is rotatably driven by the second rotatable shaft. In these embodiments, the pumping mechanism further includes an idler gear attached to an idler shaft also disposed within the pumping chamber with a plurality of idler gear teeth intermeshed with the drive gear teeth.

In certain embodiments, both the motor module and pump housing of the pumping module may each include a plurality of fastener holes formed on surfaces thereof and configured to align with each other. Accordingly, the pumping module may be removably attached to the motor module using a plurality of fasteners passing through the aligned fastener holes.

In certain embodiments, the pump may further include a mechanical seal assembly disposed between the motor module and the pumping module. A portion of the second rotatable shaft may pass through the mechanical seal assembly. In one variation, the mechanical seal assembly may include a drive collar fastened to the second rotatable shaft, disposed coaxially with the second rotatable shaft and having a first engagement mechanism. The mechanical seal assembly may further include a rotary ring also disposed coaxially with the second rotatable shaft, the rotary ring also having a second engagement mechanism configured to engage the first engagement mechanism. The mechanical seal assembly may further include a stationary ring disposed coaxially with the second rotatable shaft fastened to the pumping module adjacent the drive shaft opening. The mechanical seal assembly may further include a compressible spring disposed coaxially with the second rotatable shaft between the drive collar and the rotary ring, the spring biasing the rotary ring against the stationary ring.

In another variation, the mechanical seal assembly may include a drive collar secured to the second rotatable shaft by, the drive collar being disposed coaxially with the second rotatable shaft, the pin passing through the drive collar and the second rotatable shaft such that at least one end of the pin extends out from the drive collar. The mechanical seal assembly may further include a rotary ring disposed coaxially with the second rotatable shaft, the rotary ring having at least one engagement mechanism for engaging with the one or more ends of the pin. The mechanical seal assembly may further include a stationary ring disposed coaxially with the second rotatable shaft fastened to the pumping module adjacent the drive shaft opening. The mechanical seal assembly may further include a compressible spring disposed coaxially with the second rotatable shaft between the drive collar and the rotary ring, the spring biasing the rotary ring against the stationary ring.

In certain embodiments, the second rotatable shaft of the pumping module may be supported by a first bearing disposed between the motor module and the pumping module and a second bearing disposed within the pumping chamber.

In certain embodiments, the polymeric coupler of the pumping module may be formed from plastic, such as polypropylene.

In certain embodiments, the polymeric coupler of the pumping module may include an inner surface that is configured to engage with the first rotatable shaft and an outer surface that is configured to engage with the second rotatable shaft.

In a second aspect, the present disclosure provides a coffee making machine, the coffee making machine including a water supply, a pump, a water heating module, and a brewing module. The pump of the coffee making machine may include a motor module, the motor module including an electric motor and a first rotatable drive shaft driven by the electric motor, a pumping module that is removably attached to the motor module, and a polymeric coupler having a first end and a second end. The pumping module includes a pump housing with an internal pumping chamber, a drive shaft opening, and an inlet port and outlet port in flow communication with the pumping chamber. The pumping module also includes a second rotatable shaft extending through the drive shaft opening in the pump housing and into the pumping chamber. The pumping module further includes a pumping mechanism driven by the second rotatable shaft disposed within the internal pumping chamber of the pump housing. The pumping mechanism is capable of receiving water from the water supply through the inlet port and into the pumping chamber at a first pressure. The pumping mechanism is also capable of discharging the water from the pumping chamber at a second, greater pressure through the outlet port. The polymeric coupler has a first end that is removably attached to the first rotatable shaft and a second end that is removably attached to the second rotatable shaft.

The water heating module of the coffee making machine is in flow communication with the pump outlet port and heats water flowing out of the pump at the second, greater pressure. The brewing module of the coffee machine is in flow communication with the water heating module and mixes the heated water from the water heating module with coffee grounds to brew coffee.

In certain embodiments, the pumping mechanism of the coffee making machine includes a gear pump. In these embodiments, the pumping mechanism includes a drive gear with a plurality of drive gear teeth disposed within the pumping chamber. The drive gear is rotatably driven by the second rotatable shaft. In these embodiments, the pumping mechanism further includes an idler gear attached to an idler shaft also disposed within the pumping chamber with a plurality of idler gear teeth intermeshed with the drive gear teeth.

In certain embodiments, both the motor module and pump housing of the pumping module of the coffee making machine may each include a plurality of fastener holes formed on the surfaces thereof configured to align with each other. Accordingly, the pumping module may be removably attached to the motor module using a plurality of fasteners passing through the aligned fastener holes.

In certain embodiments, the pump of the coffee making machine may further include a mechanical seal assembly disposed between the motor module and the pumping module. A portion of the second rotatable shaft may pass through the mechanical seal assembly. In one variation, the mechanical seal assembly may include a drive collar fastened to the second rotatable shaft, disposed coaxially with the second rotatable shaft and having a first engagement mechanism. The mechanical seal assembly may further include a rotary ring also disposed coaxially with the second rotatable shaft, the rotary ring also having a second engagement mechanism configured to engage the first engagement mechanism. The mechanical seal assembly may further include a stationary ring disposed coaxially with the second rotatable shaft fastened to the pumping module adjacent the drive shaft opening. The mechanical seal assembly may further include a compressible spring disposed coaxially with the second rotatable shaft between the drive collar and the rotary ring, the spring biasing the rotary ring against the stationary ring.

In another variation, the mechanical seal assembly may include a drive collar secured to the second rotatable shaft by, the drive collar being disposed coaxially with the second rotatable shaft, the pin passing through the drive collar and the second rotatable shaft such that at least one end of the pin extends out from the drive collar. The mechanical seal assembly may further include a rotary ring disposed coaxially with the second rotatable shaft, the rotary ring having at least one engagement mechanism for engaging with the one or more ends of the pin. The mechanical seal assembly may further include a stationary ring disposed coaxially with the second rotatable shaft fastened to the pumping module adjacent the drive shaft opening. The mechanical seal assembly may further include a compressible spring disposed coaxially with the second rotatable shaft between the drive collar and the rotary ring, the spring biasing the rotary ring against the stationary ring.

In certain embodiments, the second rotatable shaft of the pumping module of the coffee making machine may be supported by a first bearing disposed between the motor module and a second bearing disposed within the pumping chamber.

In certain embodiments, the polymeric coupler of the pumping module of the coffee making machine may be formed from plastic, such as polypropylene.

In certain embodiments, the polymeric coupler of the pumping module of the coffee making machine may include an inner surface that is configured to engage with the first rotatable shaft and an outer surface that is configured to engage with the second rotatable shaft.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 is a side cross-sectional view of a portion of a pump showing various pump components in accordance with one embodiment of the present disclosure; front perspective view of a pump and controller system in accordance with one embodiment of the present disclosure;

FIG. 2 is a front perspective view of a motor module of a pump in accordance with one embodiment of the present disclosure; exploded perspective view of a portion of a pump and controller system in accordance with one embodiment of the present disclosure;

FIG. 3 is an exploded and cross-sectional view of a various components of a pump showing various pump components in accordance with one embodiment of the present disclosure;

FIG. 4 is a front perspective view of a pumping module of a pump in accordance with one embodiment of the present disclosure;

FIG. 5 is an exploded view of a mechanical seal assembly in accordance with one embodiment of the present disclosure; and

FIG. 6 is a schematic diagram illustrating a coffee making machine in accordance with one embodiment of the present disclosure.

### DETAILED DESCRIPTION

The present disclosure relates to a pump having a removable pump head. The pump described herein is particularly suited for providing pumping fluids such as water through coffee making machines and other appliances.

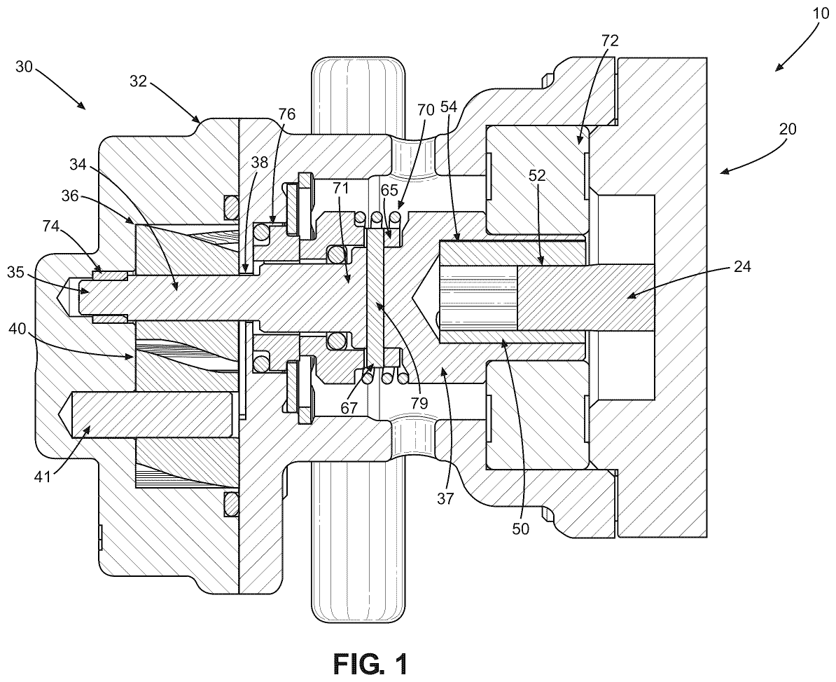

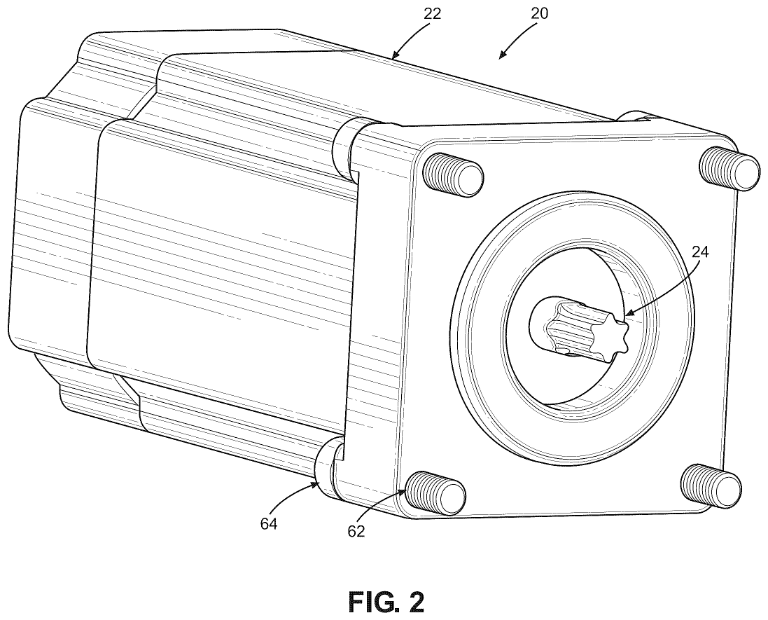

Shown in FIG. 1, a pump 10 according to the present disclosure includes a motor module 20 comprising a first rotatable shaft 24. The motor module 20 also comprises a pump motor 22, shown in FIG. 2. The pump motor 22 is preferably an electric motor; however, the pump motor 22 may alternatively be powered by other means such as by fuel combustion. The first rotatable shaft 24 is generally attached to the electric motor 22 and driven thereby. The first rotatable shaft 24 is preferably made from a metal such as steel.

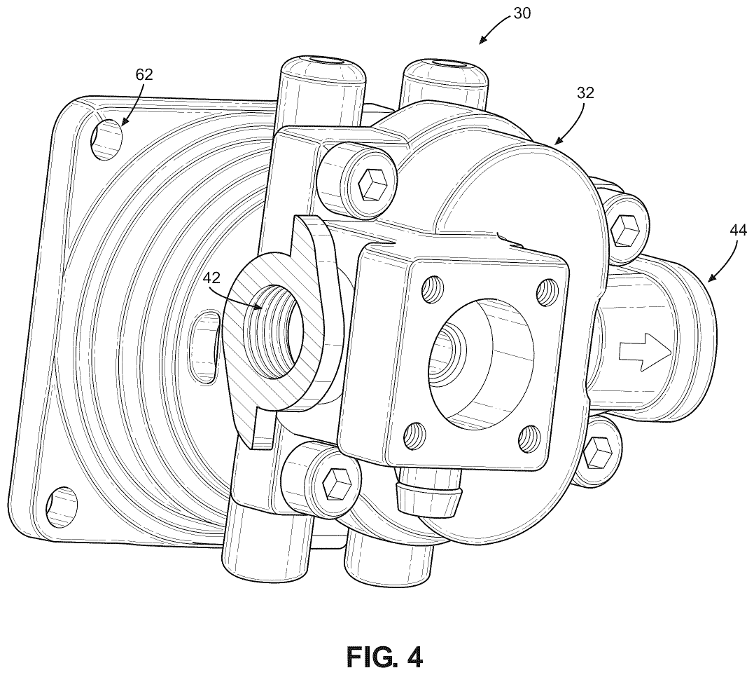

Pump 10 also comprises a pumping module 30 having a pump housing 32, the pump housing 32 having an internal pumping chamber 36 and drive shaft opening 38, as well as an inlet port 42 and outlet port 44, shown in FIG. 4, each port in flow communication with the internal pumping chamber 36. The pump housing 32 is generally formed from a high strength material such as brass, stainless steel, or another metal or alloy. Alternatively, the pump housing 32 may be molded from a polymeric material, preferably a polymeric material embedded with a fiber reinforcement material such as reinforcing carbon fiber or fiberglass filaments.

The pumping module 30 further comprises a pumping mechanism 40 that is at least partially disposed within the internal pumping chamber 36. The pumping mechanism 40 is capable of receiving a fluid through the inlet port 42 into the internal pumping chamber 36 at a first pressure and discharging the fluid from the internal pumping chamber 36 through the outlet port 44 at a second pressure that is greater than the first pressure.

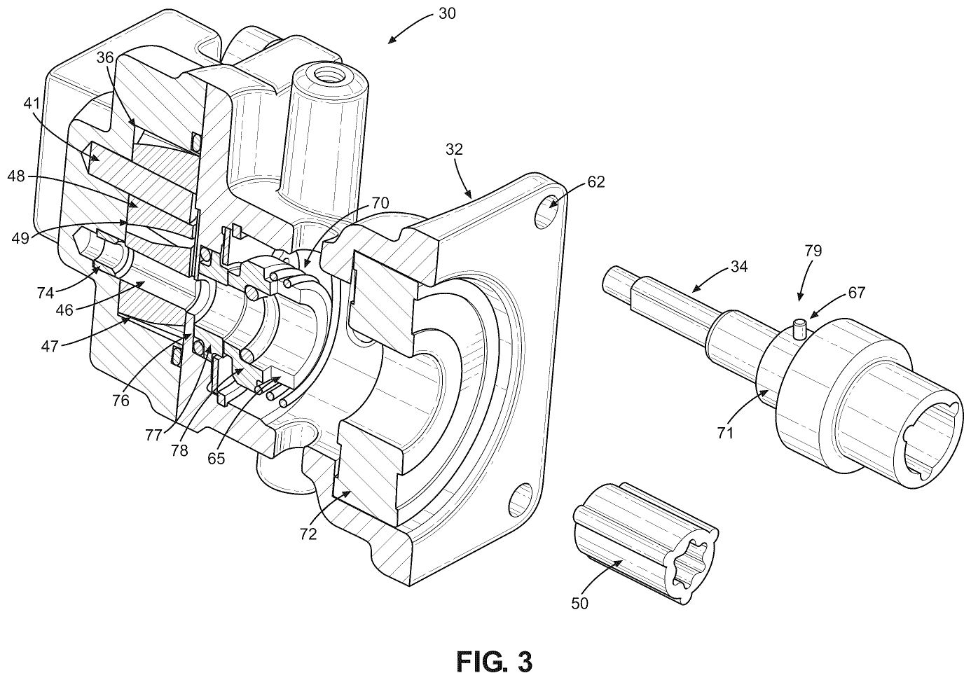

The pumping mechanism 40 is driven by the pump motor 22 via a second rotatable shaft 34 having a first end 35 and second end 37. The first end 35 of the second rotatable shaft 34 extends through the drive shaft opening 38 and into the internal pumping chamber 36. The second end 37 of the second rotatable shaft 34 extends through the pump housing 32 away from the internal pumping chamber 36. The second rotatable shaft 34 is coupled to the first rotatable shaft 24 by a polymeric coupler 50. In some embodiments, the polymeric coupler 50 may have a first end and second end, with the first end removably attached to the first rotatable shaft 24 and the second end removably attached to the second rotatable shaft 34. In other embodiments, shown in FIGS. 1 and 3, the polymeric coupler 50 may have an inner surface 52 configured to engage with the first rotatable shaft 24 and an outer surface 54 configured to engage with the second end 37 of the second rotatable shaft 34. Thus, the pump motor 22 drives the first rotatable shaft 24 which, when coupled to the second rotatable shaft 34 by polymeric coupler 50, drives the second rotatable shaft 34 and operates the pumping mechanism 40. The polymeric coupler 50 may be formed from materials such as polypropylene or other materials with similar suitable properties for the application.60

The nature of the pumping mechanism 24 may vary in different embodiments of the present disclosure. In some instances, the pumping mechanism 24 may be a centrifugal pumping mechanism. In other instances, the pumping mechanism 24 may be a positive displacement pumping mechanism. For instance, in one embodiment, the pump 10 may comprise a positive displacement rotary vane pump, and the pumping mechanism 24 may include a pump liner disposed within the internal pumping chamber 36, together with other moving and static pump parts, such as a rear cap, endplate, O-rings, bearings, seals, rotor, vanes, alignment pins, snap rings, shaft, pressure relief valve, port inserts, washers, inlet strainer, and the like.

In another preferred embodiment, the pump 10 may be provided as a positive displacement gear pump. According to this embodiment, the pump housing 32 is preferably oval shaped and, as discussed above, comprises an internal pumping chamber 36, an inlet port 42, and an outlet port 44. The pump housing 32 further comprises a drive shaft opening 38 through which the first end 35 of the second rotatable shaft 34 extends into the pump housing 32. The pumping mechanism 40 comprises a drive gear 46 and an idler gear 48. The drive gear 46 includes a plurality of drive gear teeth 47 and is disposed within the internal pumping chamber 36 and rotatably driven by the second rotatable shaft 34. The idler gear 48 includes a plurality of idler gear teeth 49 that are intermeshed with the drive gear teeth 47 so that the idler gear 48 is rotatable when the drive gear 46 is driven by the second rotatable shaft 34. The idler gear 48 is disposed within the pumping chamber 36 and is attached to an idler shaft 41 also disposed within the internal pumping chamber 36.

For the above positive displacement gear pump embodiment of the pump 10, during operation fluid is received into the internal pumping chamber 36 from the inlet port 42 at a first or initial pressure. The second rotatable drive shaft 34 rotates the drive gear 46 that in turn rotates the idler gear 48 due to the intermeshed gear teeth 47, 49 of the two gears 46, 48, respectively. As the two gears rotate, fluid is trapped by the gear teeth. The fluid then travels around the inner perimeter of the internal pumping chamber 36 until it is forced out through the outlet port 44 at a second pressure which is greater than the first or initial pressure.

Noted above, the polymeric coupler 50 is removably attached to first and second rotatable shafts 24, 34 such that the motor module 20 and pumping module 30 can be quickly and easily disconnected to one another. In one preferred embodiment, the motor module 20 and pumping module 30 may be removably attached to each other via a plurality of fasteners 64. In such an embodiment, both a surface the pump housing 32 of the pumping module 30 and a surface of the motor module 20 may comprise a plurality of fastener holes 62. The fastener holes 62 on the surface of the pump housing 32 may be configured to align with the fastener holes 62 of the motor module 20 such that when the fastener holes 62 are aligned, fasteners 64 passing through the fastener holes 62 removably attach the motor module 20 to the pumping module 30.

Shown in FIGS. 1, 3, and 5 the pump 10 may further comprise a mechanical seal assembly 76 disposed between the pumping module 30 and the motor module 20. In some embodiments a portion of the second rotatable shaft 34 may pass through an opening in the mechanical seal assembly 76 and into the internal pumping chamber 36 through the drive shaft opening 38. The mechanical seal assembly 76 may include a stationary ring 77, a rotary ring 78, and a drive collar 71. The mechanical seal assembly 76 is designed to keep fluids pumped through the pumping chamber 36 from exiting the pump housing 32 through drive shaft opening 38 while also allowing the second rotatable shaft 34 to freely rotate. In some embodiments, the stationary ring 77 is connected to the pump housing 32 and acts as a seat or stationary face. The rotary ring 78 acts as a rotary face, contacting the stationary face while connected to the second rotatable shaft 34 and rotating with the second rotatable shaft 34 via the drive collar 71 as it is driven by the pump motor 22.

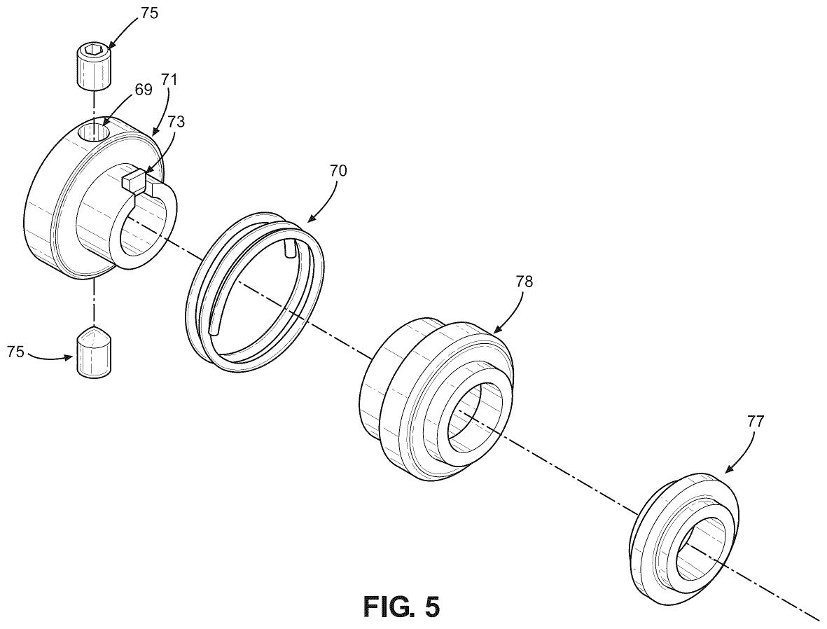

In one variation shown in FIG. 5, the rotary ring 78 may be connected to the second rotatable shaft 34 through the use of a drive collar 71 having a first engaging mechanism 73, such as a projection like a lip or catch, and also having one or more fasteners 75. In this variation, fasteners 75, such as set screws, may secure the drive collar 71 to the second rotatable shaft 34, the fasteners 75 disposed through the drive collar 71 through one or more apertures 69 extending through the drive collar 71, with ends of the fasteners 75 contacting the second rotatable shaft 34. The first engaging mechanism 73 may be configured to engage with corresponding second engagement mechanisms 65 of the rotary ring 78, such as recesses, slots, or grooves. Thus, as the second rotatable shaft 34 rotates, the rotary ring 78 rotates, engaged with the drive collar 71, which is fastened to the second rotatable shaft 34 by fasteners 75 extending through apertures 69 in the drive collar 71. In some variations, the apertures 69 and fasteners 75 may be threaded. In some variations, the second rotatable shaft 34 may have features in locations along the length of the shaft corresponding to where the ends of the fasteners 75 contact the second rotatable shaft 34 through the apertures 69 in the drive collar 71, such as depressions, if the ends of the fasteners 75 are pointed, or flat surfaces, if the ends of the fasteners 75 are substantially flat. In these embodiments, features along the length of the second rotatable shaft 34 ensure the fasteners 75 keep the drive collar 71 securely fastened to the second rotatable shaft 34 as it rotates, reducing any slippage at the point where the fasteners 75 contact the second rotatable shaft 34.

In another variation shown in FIGS. 1 and 3, the rotary ring 78 may be connected to the second rotatable drive shaft 34 through the use of a pin 79 (which may be a solid piece of material) or other similar components disposed through the drive collar 71 and the second rotatable shaft 34. In some embodiments, the pin 79 may be disposed through the drive collar 71 and second rotatable shaft 34 substantially perpendicularly. In some embodiments, the drive collar 71 may be integrally formed with the second rotatable shaft 34. In other embodiments, apertures in the drive collar 71 may be configured to align with apertures in the second rotatable shaft 34, through which the pin 79 is configured to be disposed, leaving one or more ends 67 of the pin 79 exposed, the ends 67 configured to engage with corresponding engaging mechanisms 65, such as recesses, located on the rotary ring 78. Thus, as the second rotatable shaft 34 rotates, the rotary ring 78 rotates, engaged with the drive collar 71 via the ends 67 of the pin 79, the drive collar 71 locked to the second rotatable shaft 34 by the pin 79. The pin 79 is a significant improvement over existing designs using set screws and other features to connect rotary rings to drive shafts because it assembles more easily than and will not loosen like set screws, uses fewer parts, is dynamically balanced as the shaft rotates, and because at certain loads, design features on other drives may wear, fracture, or otherwise damage rotary rings. Additionally, the stationary ring 77 and rotary ring 78 may comprise various materials in whole or in part, such as at the faces of the rings where they contact one another. In a preferred embodiment, the stationary ring 77 may comprise silicon carbide and the rotary ring 78 may comprise carbon. In other embodiments, the stationary ring 77 and rotary ring 78 may comprise, without limitation, carbon impregnated with various materials such as resin or antimony, various other carbide and oxide materials such as tungsten carbide or alumina oxide, engineered plastics, ceramic materials, or other materials with similar suitable characteristics for the application. The mechanical seal assemblies described herein may also comprise a spring 70 disposed between the rotary ring 78 and the drive collar 71 so as to bias the rotary ring 78 against the stationary ring 77, as well as various snap rings, O-rings, washers, and more as necessary to maintain stability and compression between the rotary ring 78 and stationary ring 77 as the faces of the rings wear and to ensure a leak proof seal.

In one embodiment, the pump 10 may further comprise a plurality of bearings that support and stabilize the second rotatable shaft 34 and facilitate smooth movement of the first and second rotatable shafts 24, 34. In one embodiment, there may be a first bearing 72 contacting the second rotatable shaft 34 disposed between the motor module 20 and the pumping module 30, through which the second end 37 of the second rotatable shaft 34 is disposed. There may also be a second bearing 74 contacting the second rotatable shaft 34 disposed within the internal pumping chamber 36, through which the first end 35 of the second rotatable shaft 34 is disposed.

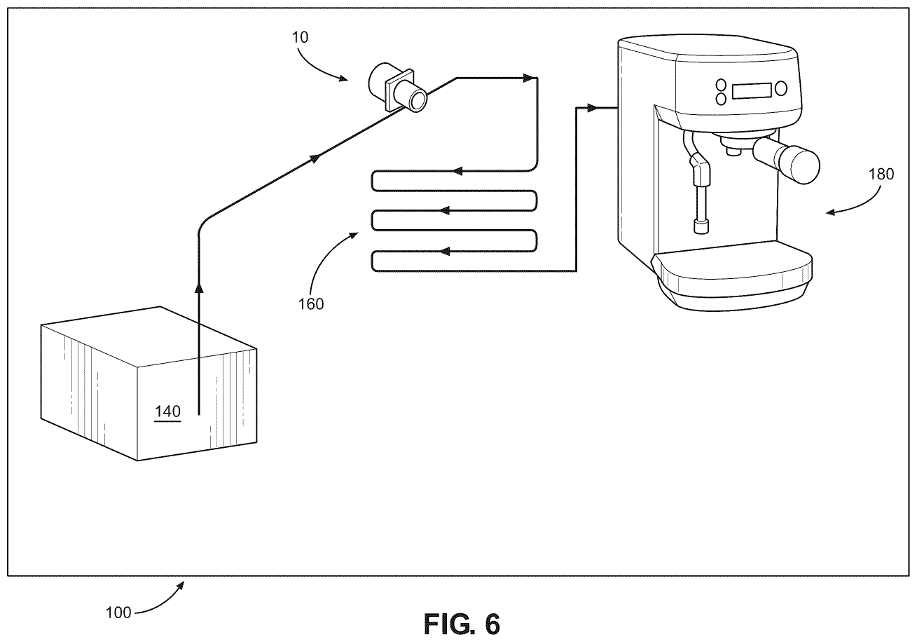

In a further aspect, the present disclosure also relates to a coffee making machine 100 that utilizes a pump 10 as described above. As shown in FIG. 6, the coffee making machine 100 also comprises a water supply 140, a water heating module 160, and a brewing module 180. During operation, water at a first pressure from the water supply 140 enters the pump 10 through the inlet port 42 and exits the pump 10 through the outlet port 44 at a second greater pressure. The water heating module 160 of the coffee making machine 100 is in flow communication with the pump outlet port 42 and heats the water exiting the pump outlet port 42 at the second pressure. The brewing module 180 is in flow communication with the water heating module 160 and mixes the heated water with coffee grounds to brew coffee, dispensed through the coffee outlet 170.

Advantageously then, according to the present disclosure, a pump 10 and a coffee making machine 100 incorporating pump 10 is disclosed that provides an easily replaced pumping module 30 and operates using an intuitive and mechanically simple, yet effective design. The disclosed pump 10 allows users to quickly and easily swap various commonly worn pumping components such as seals, bearings, drive shafts, pumping mechanism components, and more all at once, without discarding the longer lasting pump motor.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. A pump comprising:
a motor module, wherein the motor module comprises an electric motor and a first rotatable shaft driven by the electric motor;
a pumping module which is removably attached to the motor module, wherein the pumping module comprises
a pump housing having an internal pumping chamber, a drive shaft opening, an inlet port, and an outlet port, each of the ports being in flow communication with the pumping chamber,
a second rotatable shaft extending through the drive shaft opening and into the pumping chamber,
a pumping mechanism driven by the second rotatable shaft and disposed within the pumping chamber, the pumping mechanism being capable of receiving a fluid through the inlet port into the pumping chamber at a first pressure and discharging the fluid from the pumping chamber through the outlet port at a second pressure which is greater than the first pressure; and
a polymeric coupler having an inner surface having one or more inner surface engaging mechanisms and an outer surface having one or more outer surface engaging mechanisms, each of the one or more inner surface engaging mechanisms and one or more outer surface engaging mechanisms dimensioned and configured for engaging corresponding engaging mechanisms of one of the first rotatable shaft and the second rotatable shaft such that one of the first rotatable shaft and the second rotatable shaft is operable to be removably attached to the inner surface of the polymeric coupler and one of the first rotatable shaft and the second rotatable shaft is operable to be removably attached to the outer surface of the polymeric coupler.

2. The pump of claim 1, wherein the pumping mechanism comprises:
a drive gear, having a plurality of drive gear teeth, disposed within the pumping chamber and rotatably driven by the second rotatable shaft; and
an idler gear, having a plurality of idler gear teeth intermeshed with the drive gear teeth, disposed within the pumping chamber and attached to an idler shaft disposed within the pumping chamber.

3. The pump of claim 1, wherein the motor module comprises a plurality of fastener holes formed on a surface thereof, and the pump housing comprises a plurality of fastener holes formed on a surface thereof and configured to align with the fastener holes of the motor module, so that the pumping module may be removably attached to the motor module using a plurality of fasteners passing through the respective fastener holes of the motor module and the pump housing.

4. The pump of claim 1, further comprising a mechanical seal assembly disposed between the motor module and the pumping module so that a portion of the second rotatable shaft passes through the mechanical seal assembly, the mechanical seal assembly including:
a drive collar fastened to the second rotatable shaft, the drive collar being disposed coaxially with the second rotatable shaft and further having a first engagement mechanism,
a rotary ring disposed coaxially with the second rotatable shaft and having a second engagement mechanism for engaging the first engagement mechanism, and
a stationary ring disposed coaxially with the second rotatable shaft and fastened to the pumping module adjacent the drive shaft opening, and
a compressible spring disposed coaxially with the second rotatable shaft between the drive collar and the rotary ring, wherein the spring biases the rotary ring against the stationary ring.

5. The pump of claim 1, further comprising a mechanical seal assembly disposed between the motor module and the pumping module so that a portion of the second rotatable shaft passes through the mechanical seal, the mechanical seal assembly including:
a drive collar disposed coaxially with the second rotatable shaft and secured to the second rotatable shaft by a pin, the pin passing through the drive collar and the second rotatable shaft such that at least one end of the pin extends out from the drive collar,
a rotary ring disposed coaxially with the second rotatable shaft and having at least one engagement mechanism for engaging the end of the pin,
a stationary ring disposed coaxially with the second rotatable shaft and fastened to the pumping module adjacent the drive shaft opening, and
a compressible spring disposed coaxially with the second rotatable shaft between the drive collar and the rotary ring, wherein the spring biases the rotary ring against the stationary ring.

6. The pump of claim 1, wherein the second rotatable shaft is supported by a first bearing disposed between the motor module and the pumping module and a second bearing disposed within the pumping chamber.

7. The pump of claim 1, wherein the polymeric coupler is formed from polypropylene.

8. The pump of claim 1, wherein each of the inner surface and the outer surface of the polymeric coupler is configured to slidably receive one of the first rotatable shaft and the second rotatable shaft for removably attaching the first rotatable shaft and the second rotatable shaft to the polymeric coupler. configured to engage with the first

9. A coffee making machine comprising:
a water supply;
a pump comprising
a motor module, wherein the motor module comprises an electric motor and a first rotatable shaft driven by the electric motor;
a pumping module which is removably attached to the motor module, wherein the pumping module comprises
a pump housing having an internal pumping chamber, a drive shaft opening, an inlet port in flow communication with the water supply, and an outlet port, each of the ports being in flow communication with the pumping chamber,
a second rotatable shaft extending through the drive shaft opening and into the pumping chamber,
a pumping mechanism driven by the second rotatable shaft and disposed within the pumping chamber, the pumping mechanism being capable of receiving a fluid through the inlet port into the pumping chamber at a first pressure and discharging the fluid from the pumping chamber through the outlet port at a second pressure which is greater than the first pressure; and
a polymeric coupler having an inner surface having one or more inner surface engaging mechanisms and an outer surface having one or more outer surface engaging mechanisms, each of the one or more inner surface engaging mechanisms and one or more outer surface engaging mechanisms dimensioned and configured for engaging corresponding engaging mechanisms of one of the first rotatable shaft and the second rotatable shaft such that one of the first rotatable shaft and the second rotatable shaft is operable to be removably attached to the inner surface of the polymeric coupler and one of the first rotatable shaft and the second rotatable shaft is operable to be removably attached to the outer surface of the polymeric coupler;
a water heating module in flow communication with the pump outlet port for heating water flowing out of the pump at the second pressure; and
a brewing module in flow communication with the water heating module for mixing heated water from the heating module with coffee grounds in order to brew coffee.

10. The coffee making machine of claim 9, wherein the pumping mechanism comprises:
a drive gear, having a plurality of drive gear teeth, disposed within the pumping chamber and rotatably driven by the second rotatable shaft; and
an idler gear, having a plurality of idler gear teeth intermeshed with the drive gear teeth, disposed within the pumping chamber and attached to an idler shaft disposed within the pumping chamber.

11. The coffee making machine of claim 9, wherein the motor module comprises a plurality of fastener holes formed on a surface thereof, and the pump housing comprises a plurality of fastener holes formed on a surface thereof and configured to align with the fastener holes of the motor module, so that the pumping module may be removably attached to the motor module using a plurality of fasteners passing through the respective fastener holes of the motor module and the pump housing.

12. The coffee making machine of claim 9, further comprising a mechanical seal assembly disposed between the motor module and the pumping module so that a portion of the second rotatable shaft passes through the mechanical seal assembly, the mechanical seal assembly including:
a drive collar fastened to the second rotatable shaft, the drive collar being disposed coaxially with the second rotatable shaft and further having a first engagement mechanism,
a rotary ring disposed coaxially with the second rotatable shaft and having a second engagement mechanism for engaging the first engagement mechanism,
a stationary ring disposed coaxially with the second rotatable shaft and fastened to the pumping module adjacent the drive shaft opening, and
a compressible spring disposed coaxially with the second rotatable shaft between the drive collar and the rotary ring, wherein the spring biases the rotary ring against the stationary ring.

13. (canceled)

14. The coffee making machine of claim 9, wherein the second rotatable shaft is supported by a first bearing disposed between the motor module and the pumping module and a second bearing disposed within the pumping chamber.

15. The coffee making machine of claim 9, wherein the polymeric coupler is formed from polypropylene.

16. The coffee making machine of claim 9, wherein each of the inner surface and the outer surface of the polymeric coupler is configured to slidably receive one of the first rotatable shaft and the second rotatable shaft for removably attaching the first rotatable shaft and the second rotatable shaft to the polymeric coupler.

17. The pump of claim 8, wherein the one or more engaging mechanisms of the inner surface of the polymeric coupler includes a plurality of spaced apart engaging mechanisms each extending along a length of the inner surface and the one or more engaging mechanisms of the outer surface of the polymeric coupler includes a plurality of spaced apart engaging mechanisms each extending along a length of the outer surface.

18. The coffee making machine of claim 16, wherein the one or more engaging mechanisms of the inner surface of the polymeric coupler includes a plurality of spaced apart engaging mechanisms each extending along a length of the inner surface and the one or more engaging mechanisms of the outer surface of the polymeric coupler includes a plurality of spaced apart engaging mechanisms each extending along a length of the outer surface.
